(19) United States
(12) Patent Application Publication
(10) Pub. No.: US 2003/0088532 A1
(43) Pub. Date: May 8, 2003

(54) Method and apparatus for learning to classify patterns and assess the value of decisions

(76) Inventor: John B. Hampshire II, Poughkeepsie, NY (US)

Correspondence Address: Harold V. Stotland, Seyfarth Shaw, 55 East Monroe Street, Suite 4200, Chicago, IL, 60603-5803, US

(21) Appl. No.: 10/223,849

(22) Filed: Aug. 20, 2002

Related U.S. Application Data
(60) Provisional application No. 60/328,674, filed on Oct. 11, 2001.

(51) Int. Cl. G06E 1/00; G06E 3/00; G06G 7/00; G06F 15/18; G06N 3/08

(52) U.S. Cl. 706/16; 706/25

(57) ABSTRACT

An apparatus and method for training a neural network model to classify patterns or to assess the value of decisions associated with patterns by comparing the actual output of the network in response to an input pattern with the desired output for that pattern on the basis of a Risk Differential Learning (RDL) objective function, the results of the comparison governing adjustment of the neural network model's parameters by numerical optimization. The RDL objective function includes one or more terms, each being a risk/benefit/classification figure-of-merit (RBCFM) function, which is a synthetic, monotonically non-decreasing, anti-symmetric/asymmetric, piecewise-differentiable function of a risk differential δ, which is the difference between outputs of the neural network model produced in response to a given input pattern. Each RBCFM function has mathematical attributes such that RDL can make universal guarantees of maximum correctness/profitability and minimum complexity. A strategy for profit-maximizing resource allocation utilizing RDL is also disclosed.

### RELATED APPLICATION

This application claims the benefit of the filing date of copending U.S. Provisional Application No. 60/328,674, filed Oct. 11, 2001.

### BACKGROUND

This application relates to statistical pattern recognition and/or classification and, in particular, relates to learning strategies whereby a computer can learn how to identify and recognize concepts.

Pattern recognition and/or classification is useful in a wide variety of real-world tasks, such as those associated with optical character recognition, remote sensing imagery interpretation, medical diagnosis/decision support, digital telecommunications, and the like. Such pattern classification is typically effected by trainable networks, such as neural networks, which can, through a series of training exercises, “learn” the concepts necessary to effect pattern classification tasks. Such networks are trained by inputting to them (a) learning examples of the concepts of interest, these examples being expressed mathematically by an ordered set of numbers, referred to herein as “input patterns”, and (b) numerical classifications respectively associated with the examples. The network (computer) learns the key characteristics of the concepts that give rise to a proper classification for the concept. Thus, the neural network classification model forms its own mathematical representation of the concept, based on the key characteristics it has learned. With this representation, the network can recognize other examples of the concept when they are encountered.

The network may be referred to as a classifier. A differentiable classifier is one that learns an input-to-output mapping by adjusting a set of internal parameters via a search aimed at optimizing a differentiable objective function. The objective function is a metric that evaluates how well the classifier's evolving mapping from feature vector space to classification space reflects the empirical relationship between the input patterns of the training sample and their class membership. Each one of the classifier's discriminant functions is a differentiable function of its parameters. If we assume that there are C of these functions, corresponding to the C classes that the feature vector can represent, these C functions are collectively known as the discriminator. Thus, the discriminator has a C-dimensional output. The classifier's output is simply the class label corresponding to the largest discriminator output. In the special case of C=2, the discriminator may have only one output in lieu of two, that output representing one class when it exceeds its mid-range value and the other class when it falls below its midrange value.

The objective of all statistical pattern classifiers is to implement the Bayesian discriminant Function (“BDF”), i.e., any set of discriminant functions that guarantees the lowest probability of making a classification error in the pattern recognition task. A classifier that implements the BDF is said to yield Bayesian discrimination. The challenge of a learning strategy is to approximate the BDF efficiently, using the fewest training examples and the least complex classifier (e.g., the one with the fewest parameters) necessary for the task.

Applicant has heretofore proposed a differential theory of learning for efficient neural network pattern recognition (see J. Hampshire, “A Differential Theory of Learning for Efficient Statistical Patterns Recognition”, Doctoral thesis, Carnegie Mellon University (1993)). Differential learning for statistical pattern classification is based on the Classification Figure-of-Merit (“CFM”) objective function. It was there demonstrated that differential learning is asymptotically efficient, guaranteeing the best generalization allowed by the choice of hypothesis class as the training sample size grows large, while requiring the least classifier complexity necessary for Bayesian (i.e., minimum probability-of-error) discrimination. Moreover, it was there shown that differential learning almost always guarantees the best generalization allowed by the choice of hypothesis class for small training sample sizes.

However, it has been found that, in practice, differential learning as there described cannot provide the foregoing guarantees in a number of practical instances. Also, the differential learning concept placed a specific requirement on the learning procedure associated with the nature of the data being learned, as well as limitations on the mathematical characteristics of the neural network representational model being employed to effect the classification. Furthermore, the previous differential learning analysis dealt only with pattern classification, and did not address another type of problem relating to value assessment, i.e., assessing the profit and loss potential of decisions (enumerated by outputs of the neural network model) based on the input patterns.

### SUMMARY

This application describes an improved system for training a neural network model which avoids disadvantages of prior such systems while affording additional structural and operating advantages.

There is described a system architecture and process that enable a computer to learn how to identify and recognize concepts and/or the economic value of decisions, given input patterns that are expressed numerically.

An important aspect is the provision of a training system of the type set forth, which can make discriminant efficiency guarantees of maximal correctness/profit for a given neural network model and minimal complexity requirements for the neural network model necessary to achieve a target level of correctness or profit, and can make these guarantees universally, i.e., independently of the statistical properties of the input/output data associated with the task to be learned, and independently of the mathematical characteristics of the neural network representational model employed.

Another aspect is the provision of the system of the type set forth which permits fast learning of typical examples without sacrificing the foregoing guarantees.

In connection with the foregoing aspects, another aspect is the provision of a system of the type set forth which utilizes a neural network representational model characterized by adjustable (learnable), interrelated, numerical parameters, and employs numerical optimization to adjust the model's parameters.

In connection with the foregoing aspect, a further aspect is the provision of a system of the type set forth, which defines a synthetic monotonically non-decreasing, anti-symmetric/asymmetric piecewise everywhere differentiable objective function to govern the numerical optimization.

A still further aspect is the provision of a system of the type set forth, which employs a synthetic risk/benefit/classification figure-of-merit function to implement the objective function.

In connection with the foregoing aspect, a still further aspect is the provision of a system of the type set forth, wherein the figure-of-merit function has a variable argument δ which is a difference between output values of the neural network in response to an input pattern, and has a transition region for values of δ near zero, the function having a unique symmetry within the transition region and being asymmetric outside the transition region.

In connection with the foregoing aspect, a still further aspect is the provision of a system of the type set forth, wherein the figure-of-merit function has a variable confidence parameter ψ, which regulates the ability of the system to learn increasingly difficult examples.

Yet another aspect is the provision of a system of the type set forth, which trains a network to perform value assessment with respect to decisions associated with input patterns.

In connection with the foregoing aspect, a still further aspect is the provision of a system of the type set forth, which utilizes a generalization of the objective function to assign a cost to incorrect decisions and a profit to correct decisions.

In connection with the foregoing aspects, yet another aspect is the provision of a profit maximizing resource allocation technique for speculative value assessment tasks with non-zero transaction costs.

Certain ones of these and other aspects may be attained by providing a method of training a neural network model to classify input patterns or assess the value of decisions associated with input patterns, wherein the model is characterized by interrelated, numerical parameters which are adjustable by numerical optimization, the method comprising: comparing an actual classification or value assessment produced by the model in response to a predetermined input pattern with a desired classification or value assessment for the predetermined input pattern, the comparison being effected on the basis of an objective function which includes one or more terms, each of the terms being a synthetic term function with a variable argument δ and having a transition region for values of δ near zero, the term function being symmetric about the value δ=0 within the transition region; and using the result of the comparison to govern the numerical optimization by which parameters of the model are adjusted.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a functional block diagrammatic representation of a risk differential learning system;

FIG. 2 is a functional block diagrammatic representation of a neural network classification model that may be used in the system of FIG. 1;

FIG. 3 is a functional block diagrammatic representation of a neural network value assessment model that may be utilized in the system of FIG. 1;

FIG. 4 is a diagram illustrating an example of a synthetic risk/benefit/classification figure-of-merit function utilized in implementing the objective function of the system of FIG. 1;

FIG. 5 is a diagram illustrating the first derivative of the function of FIG. 4;

FIG. 6 is a diagram illustrating the synthetic function of FIG. 4 shown for five different values of a steepness or “confidence” parameter;

FIG. 7 is a functional block diagrammatic illustration of the neural network classification/value assessment model of FIG. 2 for a correct scenario;

FIG. 8 is an illustration similar to FIG. 7 for an incorrect scenario of the neural network model of FIG. 7;

FIG. 9 is an illustration similar to FIG. 7 for a correct scenario of a single-output neural network classification/value assessment model;

FIG. 10 is an illustration similar to FIG. 8 for an incorrect scenario of the single-output neural network model of FIG. 9;

FIG. 11 is an illustration similar to FIG. 9 for another correct scenario;

FIG. 12 is an illustration similar to FIG. 11 for another incorrect scenario; and

FIG. 13 is a flow diagram illustrating profit-optimizing resource allocation protocols utilizing a risk differential learning system like that of FIG. 1.

### DETAILED DESCRIPTION

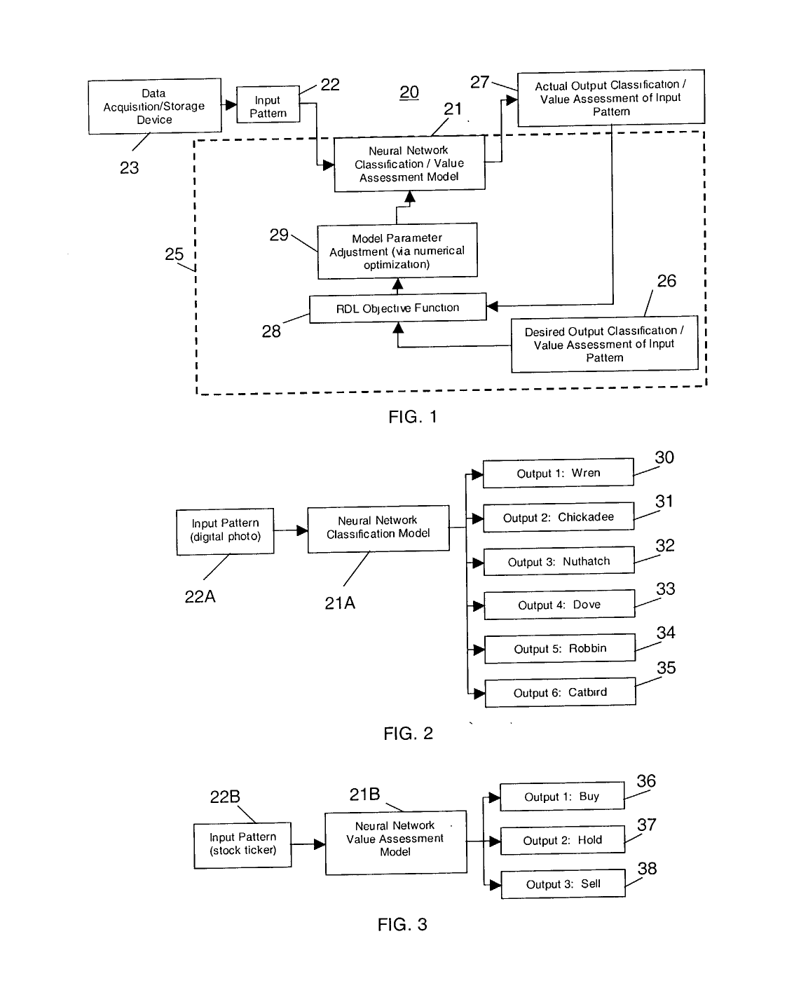

Referring to FIG. 1, there is illustrated a system 20 including a randomly parameterized neural network classification/value assessment model 21 of the concepts that need to be learned. The neural network that defines the model 21 may be any of a number of self-learning models that can be taught or trained to perform a classification or value assessment task represented by the mathematical mappings defined by the network. For purposes of this application, the term “neural network” includes any mathematical model that constitutes a parameterized set of differentiable (as defined in the study of calculus) mathematical mappings from a numerical input pattern to a set of output numbers, each output number corresponding to a unique classification of the input pattern or a value assessment of a unique decision which may be made in response to the input pattern. The neural network model can take many implementational forms. For example, it can be simulated in software running on a general-purpose digital computer. It can be implemented in software running on a digital signal-processing (DSP) chip. It can be implemented in a floating-point gate array (FPGA) or an application specific integrated circuit (ASIC). It can also be implemented in a hybrid system, comprising a general-purpose computer with associated software, plus peripheral hardware/software running on a DSP, FPGA, ASIC, or some combination thereof.

The neural network model 21 is trained or taught by presenting to it a set of learning examples of the concepts of interest, each example being in the form of an input pattern expressed mathematically by an ordered set of numbers. During this learning phase, these input patterns, one of which is designated at 22 in FIG. 1, are sequentially presented to the neural network model 21. The input patterns are obtained from a data acquisition and/or storage device 23. For example, the input patterns could be a series of labeled images from a digital camera; they could be a series of labeled medical images from an ultrasound, computer tomography scanner, or magnetic resonance imager; they could be a set of telemetry from a spacecraft; they could be “tick data” from the stock market obtained via the internet . . . any data acquisition and/or storage system that can serve a sequence of labeled examples can provide the input patterns and class/value labels required for learning. The number of input patterns in the training set may vary depending upon the choice of neural network model to be used for learning, and upon the degree of classification correctness achievable by the model, which is desired. In general, the larger the number of the learning examples, i.e., the more extensive the training, the greater the classification correctness which will be achievable by the neural network model 21.

The neural network model 21 responds to the input patterns 22 to train itself by a specific training or learning technique referred to herein as Risk Differential Learning (“RDL”). Designated at 25 in FIG. 1 are the functional blocks which effect and are affected by the Risk Differential Learning. It will be appreciated that these blocks may be implemented in a computer operating under stored program control.

Each input pattern 22 has associated with it a desired output classification/value assessment, broadly designated at 26. In response to each input pattern 22, the neural network model 21 generates an actual output classification or value assessment of the input pattern, as at 27. This actual output is compared with the desired output 26 via an RDL objective function, as at 28, which function is a measure of “goodness” for the comparison. The result of this comparison is, in turn, used to govern, via numerical optimization, adjustment of the parameters of the neural network model 21, as at 29. The specific nature of the numerical optimization algorithm is unspecified, so long as the RDL objective function is used to govern the optimization. The comparison function at 28 effects a numerical optimization or adjustment of the RDL objective function itself, which results in the model parameter adjustment at 29 which, in turn, ensures that the neural network model 21 generates actual classification (or valuation) outputs that “match” the desired ones with a high level of goodness, as at 28.

After the neural network model 21 has undergone its learning phase, by receiving and responding to each of the input patterns in the set of learning examples, the system 20 can respond to new input patterns which it has not before seen, to properly classify them or to assess the profit and loss potential of decisions which may be made in response to them. In other words, RDL is a particular process by which the neural network model 21 adjusts its parameters, learning from paired examples of input patterns and desired classification/value assessments how to perform its classification/value assessment function when presented new patterns, unseen during the learning phase.

As will be explained more fully below, having learned with RDL, the system 20 can make powerful guarantees of either maximal correctness (classification) or maximal profit (value assessment) associated with its output response to input patterns.

RDL is characterized by the following features:

1) it uses a representational model characterized by adjustable (learnable), interrelated numerical parameters;

2) it employs numerical optimization to adjust the model's parameters (this adjustment constitutes the learning);

3) it employs a synthetic, monotonically non-decreasing, anti-symmetric/asymmetric, piecewise differentiable risk/benefit/classification figure-of-merit (RBCFM) to implement the RDL objective function defined in feature 4, below;

4) it defines an RDL objective function to govern the numerical optimization;

5) for value assessment, a generalization of the RDL objective function (features 3 and 4) assigns a cost to incorrect decisions and a profit to correct decisions;

6) given large learning samples, RDL makes discriminant efficiency guarantees (see below for detailed definitions and descriptions) of;

a. maximal correctness/profit for a given neural network model;

b. minimal complexity requirements for the neural network model necessary to achieve a target level of correctness or profit;

7) the guarantees of feature 6 apply universally: they are independent of (a) the statistical properties of the input/output data associated with the classification/value assessment task to be learned,\(b) the mathematical characteristics of the neural network representational model employed, and (c) the number of classes comprising the learning task; and

8) RDL includes a profit maximizing resource allocation procedure for speculative value assessment tasks with non-zero transaction costs.

Features 3-8 are believed to make RDL unique from all other learning paradigms. The features are discussed below.

Feature 1): Neural Network Model

Referring to FIG. 2, there is illustrated a neural network classification model 21A, which is basically the neural network model 21 of FIG. 1, specifically arranged for classification of input patterns 22A which, in the illustrated example, may be digital photos of objects, such as birds. In the illustrated example, the birds belong to one of six possible species, viz., wren, chickadee, nuthatch, dove, robin and catbird. Given an input pattern 22A, the classification model 21A generates six different output values 30-35, respectively proportional to the likelihood that the input photo is a picture of each of the six possible bird species. If, for example, the value 32 of output 3 is larger than the value of any of the other outputs, the input photo is classified as a nuthatch.

Referring to FIG. 3, there is illustrated a neural network value assessment model 21B, which is essentially the neural network model 21 of FIG. 1, configured for value assessment of input patterns 22B which, in the illustrated example, may be stock ticker symbols. Given an input stock ticker data pattern, the value assessment model 21B generates three output values 36-38 which are, respectively, proportional to the profit or loss that would be incurred if each of three different decisions associated with the outputs (e.g. “buy,” “hold,” or “sell”) were taken. If, for example, the value 37 of output 2 were larger than any of the other outputs, then the most profitable decision for the particular stock ticker symbol would be to hold that investment.

Feature 2): Numerical Optimization

RDL employs numerical optimization to adjust the parameters of the neural network classification/value assessment model 21. Just as RDL can be paired with a broad class of learning models, it can be paired with a broad class of numerical optimization techniques. All numerical optimization techniques are designed to be guided by an objective function (the goodness measure used to quantify optimality). They leave the objective function unspecified because it is generally scenario-dependent. In the cases of pattern classification and value assessment, applicant has determined that a “risk-benefit-classification figure-of-merit” (RBCFM) RDL objective function is the appropriate choice for virtually all cases. As a consequence, any numerical optimization with the general attributes described below can be used for RDL. The numerical optimization must be governed by the RDL objective function 28, described below (see FIG. 1). Beyond this specific attribute, the numerical optimization procedure must be usable with a neural network model (as described above) and with the RDL objective function, described below. Thus, any one of countless numerical optimization procedures can be used with RDL. Two examples of appropriate numerical optimization procedures for RDL are “gradient ascent” and “conjugate gradient ascent.” It should be noted that maximizing the RBCFM RDL objective function is obviously equivalent to minimizing some constant minus the RBCFM RDL objective function. Consequently, references herein associated with maximizing the RBCFM RDL objective function extend to the equivalent minimization procedure.

Feature 3): RDL Objective Function's Risk/Benefit/Classification Figure-of-Merit

The RDL objective function governs the numerical optimization procedure by which the neural network classification/value assessment model's parameters are adjusted to account for the relationships between the input patterns and output classifications/value assessments of the data to be learned. In fact, this RDL-governed parameter adjustment via numerical optimization is the learning process.

The RDL objective function comprises one or more terms, each of which is a risk-benefit-classification figure-of-merit (RBCFM) function (“term function”) with a single risk differential argument. The risk differential argument is, in turn, simply the difference between the numerical values of two neural network outputs or, in the case of a single-output neural network, a simple linear function of the single output. Referring, for example, to FIG. 7, the RDL objective function is a function of the “risk differentials,” designated δ, generated at the output of the neural network classification/value assessment model 21C. These risk differentials are computed from the neural network's outputs during learning. In FIG. 7, three outputs of the neural network have been shown (although there could be any number) and have been arbitrarily arranged from top to bottom in order of increasing output value, so that output 1 is the lowest-valued output and output C is the highest-valued output. The correspondence between the input pattern 22C and its correct output classification or value assessment are indicated by showing both of them with thick outlines. (These conventions will be followed for FIGS. 7-10.) FIG. 7 illustrates the computation of the risk differentials for a “correct” scenario, wherein a C-output neural network has C−1 risk differentials, δ, which are the differences between the network's largest-valued output 63 (C in the illustrated example) corresponding to the correct classification/value assessment for the input pattern, and each of its other outputs. Thus, in FIG. 7, wherein three outputs 61-63 are illustrated, there are two risk differentials 64 and 65, respectively designated δ (1) and δ (2), both of which are positive, as indicated by the direction of the arrows extending from the larger output to the smaller output.

FIG. 8 illustrates computation of the risk differential in an “incorrect” scenario, wherein the neural network has outputs 66-68, but wherein the largest output 68 (C) does not correspond to the correct classification or value assessment output which, in this example, is output 67 (2). In this scenario, the neural network 21C has only one risk differential 69, δ (1), which is the difference between the correct output (2) and the largest-valued output (C) and is negative, as indicated by the direction of the arrow.

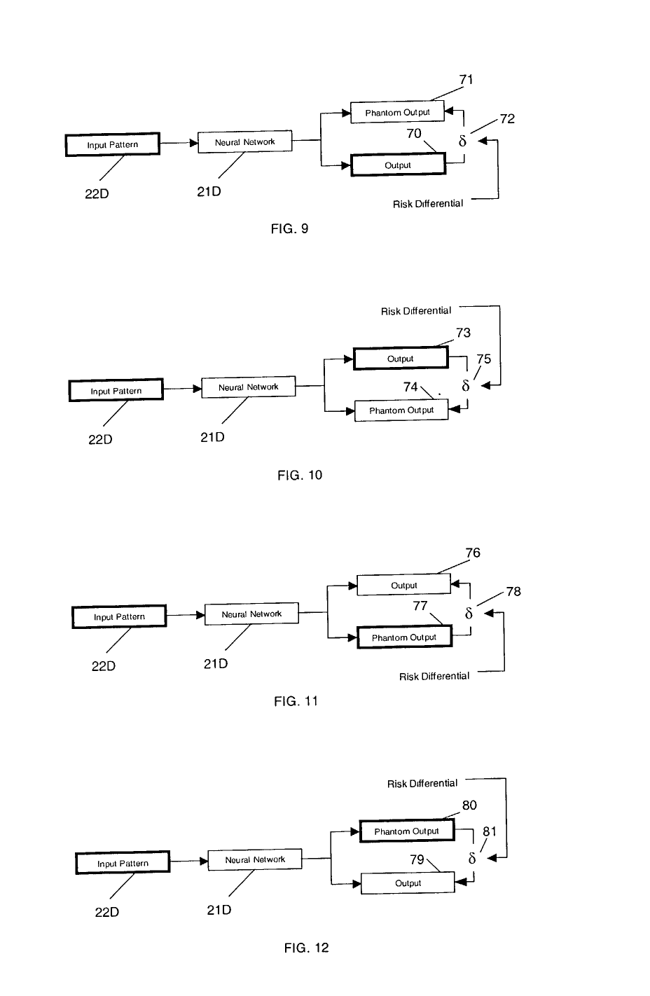

Referring to FIGS. 9 through 12, there is illustrated the special case of a single-output neural network 21 D. Note that outputs (or phantom outputs) representing the correct class in FIG. 9 through FIG. 12 have thick outlines. In FIG. 9 and FIG. 10, the input pattern 22D belongs to the class represented by the neural network's single output. In FIG. 9, the single output 70 is larger than the phantom 71, so the computed risk differential 72 is positive, and the input pattern 22D is correctly classified. In FIG. 10, the single output 73 is smaller than the phantom 74, so the computed risk differential 75 is negative, and the input pattern 22D is incorrectly classified. In FIG. 11 and FIG. 12, the input pattern 22D does not belong to the class represented by the neural network's single output. In FIG. 11, the single output 76 is smaller than its phantom 77, so the computed risk differential 78 is positive, and the input pattern 22D is correctly classified; in FIG. 12, the single output 79 is larger than the phantom 80, so the computed risk differential 81 is negative, and the input pattern 22D is incorrectly classified.

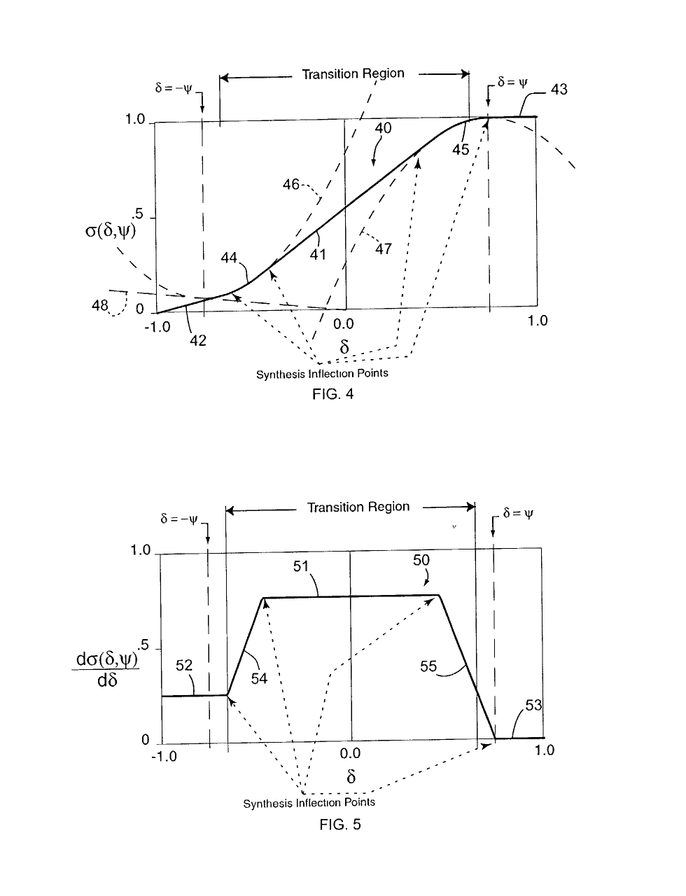

The risk-benefit-classification figure-of-merit (RBCFM) function itself has several mathematical attributes. Let the notation σ(δ,ψ) denote the RBCFM function evaluated for the risk differential δ and the steepness or confidence parameter ψ (defined below). FIG. 4 is a plot of the RBCFM function against its variable argument δ, while FIG. 5 is a plot of the first derivative of the RBCFM function shown in FIG. 4. It can be seen that the RBCFM function is characterized by the following attributes:

1. The RBCFM function must be a strictly non-decreasing function. That is, the function must not decrease in value for increasing values of its real-valued argument δ. This attribute is necessary in order to guarantee that the RBCFM function is an accurate gauge of the level of correctness or profitability with which the associated neural network model has learned to classify or value-assess input patterns.

2. The RBCFM function must be piecewise differentiable for all values of its argument δ. Specifically, the RBCFM function's derivatives must exist for all values of δ, with the following exception: the derivatives may or may not exist for those values of δ corresponding to the function's “synthesis inflection points.” Referring to FIG. 4, as an RBCFM function example, these inflection points are the points at which the natural function used to describe the synthetic function change. In the example of the RBCFM function 40 illustrated in FIG. 4, that particular function constitutes three linear segments 41-43 connected by two quadratic segments 44 and 45, which, in the illustrated example, are respectively portions of parabolas 46 and 47. The synthesis inflection points are where the constituent functional segments are connected to synthesize the overall function, i.e., where the linear segments are tangent to the quadratic segments. As can be seen in FIG. 5, the first derivative 50 of the RBCFM function 40 in which the segments 51-55 are, respectively, the first derivatives of the segments 41-45, exists for all values of δ. The second and higher-order derivatives exist for all values of 6 except the synthesis inflection points. In this particular instance of an acceptable RBCFM function, the synthesis inflection points correspond to points at which the first derivative 50 of the synthetic function 40 makes an abrupt change. Thus, derivatives of order two and higher do not exist at these points in the strict mathematical sense.

This particular characteristic stems from the fact that the constituent functions used to synthesize this particular RBCFM function in FIG. 4 are linear and quadratic functions. By being differentiable everywhere except, perhaps, at its synthesis inflection points, the objective function can be paired with a broad range of numerical optimization techniques, as was indicated above.

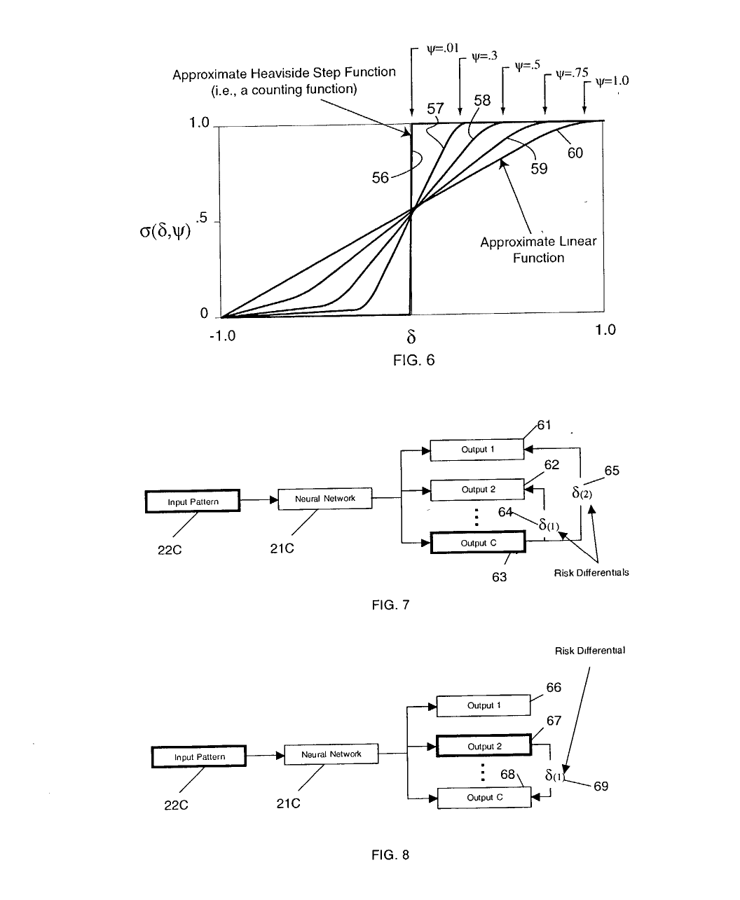

3. The RBCFM function must have an adjustable morphology (shape) that ranges between two extremes. FIGS. 4 and 5 are plots of the RBCFM function and its first derivative for a single value of the steepness or confidence parameter ψ. In FIG. 6, there are illustrated plots 56-60 of the synthetic RBCFM function shown in FIG. 4, for five different values of the steepness parameter ψ. That steepness parameter can have any value between one and zero, but not including zero. The morphology of the RBCFM function must be smoothly adjustable, by the single real-valued steepness or confidence parameter ψ, between the following two extremes.

a. An approximately linear function of its argument δ when ψ=1:

σ(δ,ψ)≈a·δ+b;ψ=1, (1)

where a and b are real numbers.

b. An approximate Heaviside step function of its argument δ when ψ approaches 0:

σ(δ,ψ)=1 if and only if δ>0, otherwise σ(δ,ψ)=0; ψ=0. (2)

Thus, as can be seen in FIG. 6, as ψ approaches 1, the RBCFM function is approximately linear. As ψ approaches zero, the RBCFM function is approximately a Heaviside step (i.e. counting) function, yielding a value of 1 for positive values of its dependent variable δ, and a value of zero for non-positive values of δ.

This attribute is necessary in order to regulate the minimal confidence (specified by ψ) with which the classifier is permitted to learn examples. Learning with ψ=1, the classifier is permitted to learn only “easy” examples—ones for which the classification or value assessment is unambiguous. Thus, the minimal confidence with which these examples can be learned approaches unity. Learning with lesser values of the confidence parameter ψ, the classifier is permitted to learn more “difficult” examples—ones for which the classification or value assessment is more ambiguous. The minimal confidence with which these examples can be learned is proportional to ψ.

The practical effect of learning with decreasing confidence values is that the learning process migrates from one that initially focuses on easy examples to one that eventually focuses on hard examples. These hard examples are the ones that define the boundaries between alternative classes or, in the case of value assessment, profitable and unprofitable investments. This shift in focus equates to a shift in the model parameters (what is termed a re-allocation of model complexity in the academic field of computational learning theory) to account for the more difficult examples. Because difficult examples have, by definition, ambiguous class membership or expected values, the learning machine requires a large number of these examples in order to unambiguously assign a most-likely classification or valuation to them. Thus, learning with decreased minimal acceptable confidence demands increasingly large learning sample sizes.

In the applicant's earlier work, the maximal value of tM depended on the statistical properties of the patterns being learned, whereas the minimal value ψ depended on i) the functional characteristics of the parameterized model being used to do the learning, and ii) the size of the learning sample. These maximal and minimal constraints were at odds with one another. In RDL, ψ does not depend on the statistical properties of the patterns being learned. Consequently, only the minimal constraint survives, which, like the prior art, depends on i) the functional characteristics of the parameterized model being used to do the learning, and ii) the size of the learning sample.

4. The RBCFM function must have a “transition region” (see FIG. 4) defined for risk differential arguments in the vicinity of zero, i.e., −T≦δ≦T, inside which the function must have a special kind of symmetry (“anti-symmetry”). Specifically, inside the transition region, the function, evaluated for the argument δ, is equal to a constant C minus the function evaluated for the negative value of the same argument (i.e., −δ):

σ(δ,ψ)=C−σ(−δ,ψ) for all |δ|≦T;δ>0 (3)

Among other things, this attribute ensures that the first derivative of the RBCFM function is the same for both positive and negative risk differentials having the same absolute value, as long as that value lies inside the transition region see FIG. 5:

d/dδσ(δ,ψ)=d/dδσ(−δ,ψ) for all |δ|≦T (4)

This mathematical attribute is essential to the maximal correctness/profitability guarantee and the distribution-independence guarantee of RDL, discussed below. Applicant's prior work required that the objective function be asymmetric (as opposed to anti-symmetric) in the transition region, in order to assure reasonably fast learning of difficult examples under certain cases. However, applicant has since determined that that asymmetry prevented the objective function from guaranteeing maximal correctness and distribution independence.

5. The RBCFM function must have its maximal slope at δ=0, and the slope cannot increase with increasing positive or decreasing negative values of its argument. The slope must, in turn, be inversely proportional to the confidence parameter ψ (see FIGS. 4 and 6 ) Thus:

$$\frac{\partial σ ( δ , ψ )}{\partial δ} ∝ {ψ}^{- 1} ; \frac{\partial }{\partial δ} σ ( \vert δ \vert , ψ ) \geq \frac{\partial σ}{\partial δ} ( \vert δ \vert + ϵ , ψ ) ; ϵ > 0 \qquad ( 5 )$$

Applicant's prior work requires that the figure-of-merit function have maximal slope in the transition region and that the slope be inversely proportional to the confidence parameter ψ, but it does not require the point of maximal slope to coincide with δ=0, nor does it prevent the slope from increasing with increasing positive or decreasing negative values of its argument.

6. The lower leg 42 of the sigmoidal RBCFM function (i.e., that portion of the function for negative values of δ outside the transition region) (see FIG. 4) must be a monotonically increasing polynomial function of δ. The minimal slope of this lower leg should be (but need not necessarily be) linearly proportional to the confidence parameter ψ (see FIG. 6). Thus:

$${min}_{δ < 0} \frac{\partial σ ( δ , ψ )}{\partial δ} ∝ ψ \qquad ( 6 )$$

Applicant's earlier work imposes the constraint that the lower leg of the sigmoidal objective function have positive slope that is linearly proportional to the confidence parameter, but it does not further explicitly require the lower leg be a polynomial function of δ. The addition of the polynomial functional constraint to the prior proportionality constraint between the function's derivative and the confidence parameter v results in a more complete requirement. To wit, the combined constraints better ensure that the first derivative of the objective function retains a significant positive value for negative values of δ outside the transition region, as long as the confidence parameter ψ is greater than zero (see FIG. 5). This, in turn, ensures that numerical optimization of the classification/value assessment model parameters does not require exponentially long convergence times when the confidence parameter ψ is small. In plain language, these combined constraints ensure that RDL learns even difficult examples reasonably fast.

7. Outside the transition region, the RBCFM function must have a special kind of asymmetry. Specifically, the first derivative of the function for positive risk differential arguments outside the transition region must not be greater than the first derivative of the function for the negative risk differential of the same absolute value see FIGS. 4 and 5. Thus:

d/dδσ(δ,ψ)≦d/dδσ(−δ,ψ) for all δ>T,0≦T<ψ (7)

Asymmetry outside the transition region is necessary to ensure that difficult examples are learned reasonably fast without affecting the maximal correctness/profitability guarantee of RDL. If the RBCFM function were anti-symmetric outside the transition region as well as inside, RDL could not learn difficult examples in reasonable time (it could take the numerical optimization procedure a very long time to converge to a state of maximal correctness/profitability). On the other hand, if the RBCFM function were asymmetric both inside and outside the transition region—as was the case in applicant's earlier work—it could guarantee neither maximal correctness/profitability nor distribution independence. Thus, by maintaining anti-symmetry inside the transition region and breaking symmetry outside the transition region, RBCFM function allows fast learning of difficult examples without sacrificing its maximal correctness/profitability and distribution independence guarantees.

The attributes listed above suggest that it is best to synthesize the RBCFM function from a piece-wise amalgamation of functions. This leads to one attribute, which, although not strictly necessary, is beneficial in the context of numerical optimization. Specifically, the RBCFM function should be synthesized from a piece-wise amalgamation of differentiable functions, with the left-most functional segment (for negative values of 6 outside the transition region) having the characteristics imposed by attribute 6, described above.

Feature 4): The RDL Objective Function (with RBCFM Classification)

As was indicated above, the neural network model 21 may be configured for pattern classification, as indicated at 21A in FIG. 2, or for value assessment, as indicated at 21B in FIG. 3. The definition of the RDL objective function is slightly different for these two configurations. We now discuss the definition of the objection function for the pattern classification application.

As depicted in FIGS. 7-10, the RDL objective function is formed by evaluating the RBCFM function for one or more risk differentials, which are derived from the outputs of the neural network classifier/value assessment model. FIGS. 7 and 8 illustrate the general case of a neural network with multiple outputs, and FIGS. 9 and 10 illustrate the special case of a neural network with a single output.

In the general case, the classification of the input pattern is indicated by the largest neural network output (see FIG. 7). During learning, the RDL objective function Φ_{RD} takes one of two forms, depending on whether or not the largest neural network output is O_{τ}, the one corresponding to the correct classification for the input pattern:

$${Φ}_{RD} = \{ \begin{matrix}{{\sum }_{j = 1}^{C}}_{j \neq τ} σ ( {\underbrace{{O}_{τ} - {O}_{j}}}_{{δ}_{τ}} , ψ ) , & {O}_{τ} > {O}_{j \neq τ} \\ σ ( {\underbrace{{O}_{τ} - {O}_{j}}}_{{δ}_{τ}} , ψ ) , & {O}_{j} \geq {O}_{k \neq j} ; j \neq τ\end{matrix} \qquad ( 8 )$$

When the neural network correctly classifies an input, equation (8), like FIG. 7, indicates that the RDL objective function Φ_{RD} is the sum of C−1 RBCFM terms, evaluated for the C−1 risk differentials between the correct output O_{τ} (which is larger than any other output, indicating a correct classification) and each of the C−1 other outputs. When O_{τ} is not the largest classifier output (indicating an incorrect classification), Φ_{RD} is the RBCFM function evaluated for only one risk differential, between the largest incorrect output (Oⱼ≦O_{k≠j};j≠τ) and the correct output O_{τ} (see FIG. 8).

In the special single-output case (see FIGS. 9 through 12 ) as it applies to classification, the single neural network output indicates that the input pattern belongs to the class represented by the output if, and only if, the output exceeds the midpoint of its dynamic range (FIGS. 9 and 12 ). Otherwise, the output indicates that the input pattern does not belong to the class (FIGS. 10 and 11). Either indication (“belongs to class” or “does not belong to class”) can be correct or incorrect, depending on the true class label for the example, a key factor in the formulation of the RDL objective function for the single-output case.

The RDL objective function is expressed mathematically as the RBCFM function evaluated for the risk differential δ_{τ} which, depending on whether the classification is correct or not, is plus or minus two times the difference between the neural network's single output O and its phantom. Note that in equation (9) the phantom is equal to the average of the maximal Oₘₐₓ and minimal Oₘᵢₙ values that O can assume.

$${Φ}_{RD} = \{ \begin{matrix}σ ( \underbrace{2 \cdot ( O - {\underbrace{\frac{( {O}_{max} + {O}_{min} )}{2}}}_{Phantom} )}_{{δ}_{τ}} , ψ ) , & O = {O}_{τ} \\ σ ( \underbrace{2 \cdot ( {\underbrace{\frac{( {O}_{max} + {O}_{min} )}{2}}}_{Phantom} - O )}_{{δ}_{τ}} , ψ ) , & O = {O}_{⫬ τ}\end{matrix} \qquad ( 9 )$$

When the neural network input pattern belongs to the class represented by the single output (O=O_{τ}) , the risk differential argument δ_{τ} for the RBCFM function is twice the output O minus its phantom (equation (9), top, FIG. 9, and FIG. 10). When the neural network input pattern does not belong to the class represented by the single output (O=O _{τ} [symbol]), the risk differential argument δ_{τ} for the RBCFM function is twice the output's phantom minus O (equation (9), bottom, FIG. 11, and FIG. 12). By expanding the arguments of equation (9), it can be shown that the outer multiplying factor of 2 ensures that the risk differential of the single-output model spans the same range it would for a two-output model applied to the same learning task.

Applicant's earlier work included a formulation which calculated the differential between the correct output and the largest other output, whether or not the example was correctly classified. While this formulation could guarantee maximal correctness, the guarantee held only if the confidence level ψ met certain data distribution-dependent constraints. In many practical cases, ψ had to be made very small for correctness guarantees to hold. This, in turn, meant that learning had to proceed extremely slowly in order for the numerical optimization to be stable and to converge to a maximally correct state. In RDL, the enumeration of the constituent differentials, as described in FIGS. 7-12 and equations (8) and (9) guarantees maximal correctness for all values of the confidence parameter ψ, independent of the statistical properties of the learning sample (i.e., the distribution of the data). This, improvement has a significant practical advantage. The effect of the earlier formulation's data distribution dependence was that difficult learning tasks could not be concluded in reasonable time. Consequently, using that prior formulation, one could learn quickly by sacrificing correctness guarantees, or one could learn with maximal correctness if one had unlimited time. RDL, in contrast, can learn even difficult tasks rapidly. Its maximal correctness guarantee does not depend on the distribution of the learning data, nor does it depend on the learning confidence parameter ψ. Moreover, learning can take place in reasonable time without affecting the maximal correctness guarantee.

Feature 5): The RDL Objective Function (with RBCFM Value Assessment)

In applicant's earlier work, the notion of learning was restricted to classification tasks (e.g., associate a pattern with one of C possible concepts or “classes” of objects). Admissible learning tasks did not include value assessment tasks. RDL does admit value assessment learning tasks. Conceptually, RDL poses a value assessment task as a classification task with associated values. Thus, an RDL classification machine might learn to identify cars and pickup trucks, whereas an RDL value assessment machine might learn to identify cars and trucks as well as their fair market values.

Using a neural network to learn to assess the value of decisions based on numerical evidence is a simple conceptual generalization of using neural networks to classify numerical input patterns. In the context of Risk Differential Learning, a simple generalization of the RDL objective function effects the requisite conceptual generalization needed for value assessment.

In learning for pattern classification, each input pattern has a single classification label associated with it—one of the C possible classifications in a C-output classifier—, but in learning for value assessment, each of the C possible decisions in a C-output value assessment neural network has an associated value.

In the special, single output/decision case as it applies to value assessment, the single output indicates that the input pattern will generate a profitable outcome if the decision represented by the output is taken—if and only if the output exceeds the midpoint of its dynamic range. Otherwise, the output indicates that the input pattern will not generate a profitable outcome if the decision is taken (see FIGS. 9 and 10). The generalization of equation (9) simply multiplies the RBCFM function by the economic value (i.e., profit or loss) Υ of an affirmative decision, represented by the neural network's single output O exceeding its phantom:

$${Φ}_{RD} = Υ \cdot σ ( \underbrace{2 \cdot ( O - \frac{( {O}_{max} + {O}_{min} )}{2} ) , ψ}_{{δ}_{τ}} ) \qquad ( 10 )$$

In the general, C-output decision case as it applies to value assessment during learning, the RDL objective function Φ_{RD} takes one of two forms, see equation (11), depending on whether or not the largest neural network output is O₉₆ , the one corresponding to the most profitable (or least costly) decision for the input pattern (see FIGS. 7 and 8):

$${Φ}_{RD} = {Υ}_{τ} \cdot \{ \begin{matrix}{{\sum }_{j = 1}^{C}}_{j \neq τ} σ ( {\underbrace{{O}_{τ} - {O}_{j}}}_{{δ}_{τ}} , ψ ) , & {O}_{τ} > {O}_{j \neq τ} \\ σ ( {\underbrace{{O}_{τ} - {O}_{j}}}_{{δ}_{τ}} , ψ ) , & {O}_{j} \geq {O}_{k \neq j} ; j \neq τ\end{matrix} \qquad ( 11 )$$

From a pragmatic, value assessment perspective, equations (10) and (11) differ according to whether there is more than one decision that can be taken, based on the input pattern. Equation (10) applies if there is only one “yes/no” decision. Equation (11) applies if the decision options are more numerous (e.g., the three mutually-exclusive securities-trading decisions “buy”, “hold”, or sell” each of which has an economic value Υ).

The ability to perform value assessment with maximal profit guarantees analogous to the maximal correctness guarantees for classification tasks has readily apparent practical utility and great significance for automated value assessment.

Feature 6): RDL Efficiency Guarantees

For pattern classification tasks, RDL makes the following two guarantees:

1. Given a particular choice of neural network model to be used for learning, as the number of learning examples grows very large, no other learning strategy will ever yield greater classification correctness. In general RDL will yield greater classification correctness than any other learning strategy.

2. RDL requires the least complex neural network model necessary to achieve a specific level of classification correctness. All other learning strategies generally require greater model complexity, and in all cases require at least as much complexity.

For value assessment tasks, RDL makes the following two analogous guarantees:

3. Given a particular choice of neural network model to be used for learning, as the number of learning examples grows very large, no other learning strategy will ever yield greater profit. In general RDL will yield greater profit than any other learning strategy.

4. RDL requires the least complex neural network model necessary to achieve a specific level of profit. All other learning strategies generally require greater model complexity.

In the value assessment context, it is important to remember that the neural network makes decision recommendations (the decisions being enumerated by the neural network's outputs), and profits are incurred by making the best decision, as indicated by the neural network.

As was indicated above, applicant's prior work did not admit of value assessment and, accordingly, it made no value assessment guarantees. Furthermore, owing to design limitations of the earlier work, addressed above, the prior work had deficiencies that effectively nullified the classification guarantees for difficult learning problems. RDL makes both classification and value assessment guarantees, and the guarantees apply to both easy and difficult learning tasks.

In practical terms, the guarantees state the following, given a reasonably large learning sample size:

(a) if a specific learning task and learning model are chosen, when these choices are paired with RDL, the resulting model, after RDL learning, will be able to classify input patterns with fewer errors or value input patterns more profitably, than it could if it had learned with any non-RDL learning strategy;

(b) alternatively, if one specifies a priori, a level of classification accuracy or profitability desired to be provided by the learning system, the complexity of the model required to provide the specified level of accuracy/profitability when paired with RDL will be the minimum necessary, i.e., no non-RDL learning strategy will be able to meet the specification with a lower-complexity model.

Appendix I contains the mathematical proofs of these guarantees, the practical significance of which is that RDL is a universally-best learning paradigm for classification and value assessment. It cannot be out-performed by any other paradigm, given a reasonably large learning sample size.

Feature 7): RDL Guarantees Are Universal

The RDL guarantees described in the previous section are universal because they are both “distribution independent” and “model independent”. This means that they hold regardless of the statistical properties of the input/output data associated with the pattern classification or value assessment task to be learned and they are independent of the mathematical characteristics of the neural network classification/value-assessment model employed. This distribution and model independence of the guarantees is, ultimately, what makes RDL a uniquely universal and powerful learning strategy. No other learning strategy can make these universal guarantees.

Because the RDL guarantees are universal, rather than restricted to a narrow range of learning tasks, RDL can be applied to any classification or value assessment task without worrying about matching or fine-tuning the learning procedure to the task at hand. Traditionally, this process of matching or fine-tuning the learning procedure to the task has dominated the computational learning process, consuming substantial time and human resources. The universality of RDL eliminates these time and labor costs.

Feature 8): Profit-Maximizing Resource Allocation

In the case of value assessment, RDL learns to identify profitable and unprofitable decisions, but when there are multiple profitable decisions that can be made simultaneously (e.g., several stocks that can be purchased simultaneously with the expectation that they all will increase in value) RDL itself does not specify how to allocate resources in a manner that maximizes the aggregate profit of these decisions. In the case of securities trading, for example, an RDL-generated trading model might tell us to buy seven stocks, but it doesn't tell us the relative amounts of each stock that should be purchased. The answer to that question relies explicitly on the RDL-generated value assessment model, but it also involves an additional resource-allocation mathematical analysis.

This additional analysis relates specifically to a broad class of problems involving three defining characteristics:

1. The transactional allocation of fixed resources to a number of investments, the express purpose being to realize a profit from such allocations;

2. The payment of a transaction cost for each allocation (e.g., investment) in a transaction; and

3. A non-zero, albeit small, chance of ruin (i.e., losing all resources—“going broke”) occurring in a sequence of such transactions.

FRANTIC Problems

All such resource allocation problems are herein called, “Fixed Resource Allocation with Non-zero Transactions Cost” (FRANTiC) problems.

The following are just a few representative examples of FRANTiC problems:

Pari-mutuel Horse Betting: deciding what horses to bet on, what bets to place, and how much money to place on each bet, in order to maximize one's profit at the track over a racing meet.

Stock Portfolio Management: deciding how many shares of stock to buy/or sell from a portfolio of many stocks at a given moment in time, in order to maximize the return on investment and the rate of portfolio value growth while minimizing wild, short-term value fluctuations.

Medical Triage: deciding what level of medical care, if any, each patient in a large group of simultaneous emergency admissions should receive—the overall goal being to save as many lives as possible.

Optimal Network Routing: deciding how to prioritize and route packetized data over a communications network with fixed overall bandwidth supply, known operational costs, and varying bandwidth demand, such that the overall profitability of the network is maximized.

War Planning: deciding what military assets to move, where to move them, and how to engage them with enemy forces in order to maximize the probability of ultimately winning the war with the lowest possible casualties and loss of materiel.

Lossy Data Compression: data files or streams that arise from digitizing natural signals such as speech, music, and video contain a high degree of redundancy. Lossy data compression is the process by which this signal redundancy is removed, thereby reducing the storage space and communications channel bandwidth (measured in bits per second) required to archive or transmit a high-fidelity digital recording of the signal. Lossy data compression therefore strives to maximize the fidelity of the recording (measured by one of a number of distortion metrics, such as peak signal to noise ratio [PSNR]) for a given bandwidth cost.

Maximizing Profit in FRANTiC Problems

Given the characteristics of FRANTiC problems, enumerated at the top of this section, the keys to profit in such problems reduce to definitions of three protocols:

1. A protocol for limiting the fraction of all resources devoted to each transaction, in order to limit to an acceptable level the probability of ruin in a sequence of such transactions.

2. Establishing, within a given transaction, the proportion of resources allocated to each investment (a single transaction can involve multiple investments).

3. A resource-driven protocol by which the fraction of all resources devoted to a transaction (established by protocol 1 ) is increased or decreased over time.

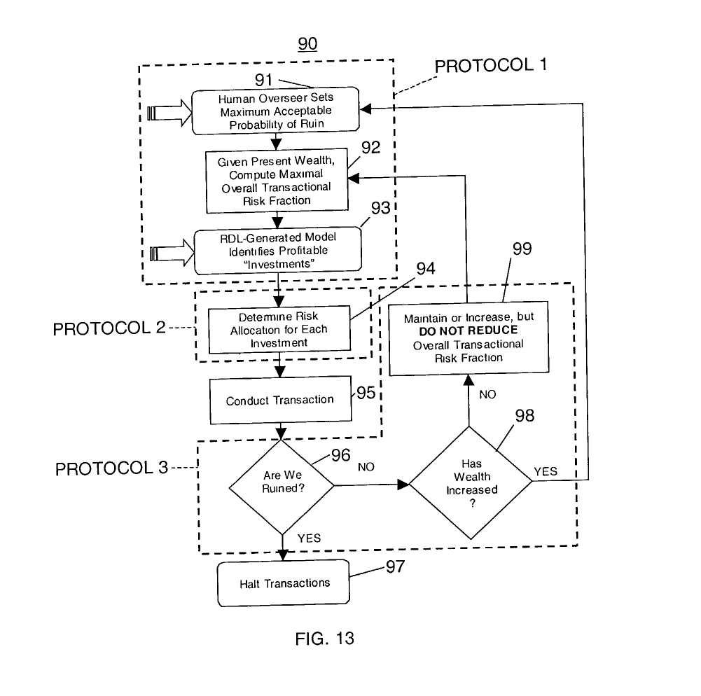

These protocols and their interrelationships are flow-charted in FIG. 13. In order to clarify the three protocols, consider the stock portfolio management example. In this case, a transaction is defined as the simultaneous purchase and/or sale of one or more securities. The first protocol establishes an upper bound on the fraction of the investor's total wealth that can be devoted to a given transaction. Given the amount of money to be allocated to the transaction, established by the first protocol, the second protocol establishes the proportion of that money to be devoted to each investment in the transaction. For example, if the investor is to allocate ten thousand dollars to a transaction involving the purchase of seven stocks, the second protocol tells her/him what fraction of that $10,000 to allocate to the purchase of each of the seven stocks. Over a sequence of such transactions, the investor's wealth will have grown or shrunken; typically her/his wealth grows over a sequence of transactions, but sometimes it shrinks. The third protocol tells the investor when and by how much (s)he may increase or decrease the fraction of wealth devoted to a transaction; that is, protocol three limits the manner and timing with which the overall transactional risk fraction, determined by protocol one for a particular transaction, should be modified in response to the affect on her/his wealth of a sequence of such transactions, occurring over time.

Protocol 1: Determining the Overall Transactional Risk Fraction

Referring to FIG. 13, a routine 90 is illustrated for resource allocation. The allocation process charted is applied to an ongoing sequence of transactions, each of which may involve one or more “investments”. Given the investor's risk tolerance (measured by her/his maximal acceptable probability of ruin) and overall wealth, a fraction of that wealth—called the “overall transactional risk fraction R”—is allocated to the transaction by the first protocol. The overall transactional risk fraction R is determined in two stages. First, the human overseer or “investor” decides on an acceptable maximum probability of ruin at 91. Recall that the third defining characteristic of FRANTiC problems is an inescapable, non-zero probability of ruin. Then, at 92, based on the historical statistical characteristics of the FRANTiC problem, this probability of ruin is used to determine the largest acceptable fraction, Rₘₐₓ, of the investor's total wealth that may be allocated to a given transaction. Appendix II provides a practical method for estimating Rₘₐₓ in order to satisfy the requirement that one skilled in the field be able to implement the invention.

Given this upper bound Rₘₐₓ, the investor can—and should—choose an overall risk fraction R that is no greater than the upper bound, Rₘₐₓ and inversely proportional to the expected profitability of this particular transaction (measured by the expected percentage net return on investment β, which information is estimated by the RDL value assessment model). Thus, fewer resources should be allocated to more profitable transactions, and vice versa, such that all transactions yield the same expected profit.

where

$$\begin{matrix}R = α \cdot \frac{1}{β} \leq {R}_{max} ; β > 0 , \\ where & ( 12 ) \\ β = \frac{{\overbrace{expected value of transaction - transaction cost}}^{expected profit / loss}}{transaction cost} > 0 , & ( 13 )\end{matrix}$$

and the RDL value assessment model generates an estimate of expected profit/loss used in equations (13) and (18) [below], having learned with the value assessment RBCFM formulation given in equation (10) or (11).

Only profitable transactions (i.e., those for which β>0) are considered. The investor chooses a minimum acceptable expected profitability (i.e., return on investment) βₘᵢₙ, from which the proportionality constant a in equation (12) is chosen to ensure that R never exceeds the upper bound Rₘₐₓ.

α≦βₘᵢₙ·Rₘₐₓ (14)

The distinction between β and βₘᵢₙ is that the former is the expected profitability for the transaction currently being considered, whereas the latter is the minimum acceptable profitability of any transaction the investor is willing to consider.

From the calculations of equations (12)-(14) yielding α, β, and R, the total assets (i.e., resources) A allocated to the transaction are equal to the overall transactional risk fraction R times the investor's total wealth W:

A=R·W (15)

Protocol 2: Determining the Resource Allocation for Each Investment of a Transaction

Just as protocol one allocates resources to each transaction in inverse proportion to the transaction's overall expected profitability, protocol two allocates resources to each constituent investment of a single transaction in inverse proportion to the investment's expected profitability. Given N investments, the fraction ρₙ of all assets A (equation (15)) allocated to the overall transaction that is allocated to the nth investment of the transaction is inversely proportional to that investment's expected profitability βₙ:

$${ρ}_{n} = ζ \cdot \frac{1}{{β}_{n}} ; {β}_{n} > 0 ∀ n , \qquad ( 16 )$$

where the n positive investment risk fractions sum to one

$${\sum }_{n = 1}^{N} {ρ}_{n} = 1 , \qquad ( 17 )$$

the nth investment's expected percentage net profitability βₙ is defined as

$${β}_{n} = \frac{\overbrace{\begin{matrix}expected value of investment n - \\ transaction cost of investment n\end{matrix}}^{expected profit / loss for investment n}}{transaction cost of investment n} > 0 , \qquad ( 18 )$$

and the proportionality factor ζ is not a constant, but instead is defined as the sum of all the investments' inverse expected profitabilities:

$$ζ = {( {\sum }_{n = 1}^{N} \frac{1}{{β}_{n}} )}^{- 1} ; {β}_{n} > 0 ∀ n \qquad ( 19 )$$

Only profitable investments (i.e., those for which βₙ>0) are considered. These profitable investments are identified at 93 in FIG. 13, using an RDL-generated model; i.e., one trained using RDL as described above. Note that the definition of ζ in equation (19) is a necessary consequence of equations (15) and (16).

Thus, the assets Aₙ allocated to the nth investment are equal to the total assets A allocated to the overall transaction, times ρₙ:

$$\begin{matrix}{A}_{n} = {ρ}_{n} \cdot A \\ = {ρ}_{n} \cdot R \cdot W\end{matrix} \qquad ( 20 )$$

This allocation is made at 94 in FIG. 13. Then at 95, the transaction is conducted.

It should be clear from a comparison of equations (12)-(15) and (16)-(20) that protocols one and two are analogous: protocol one governs resource allocation at the transaction level, whereas protocol two governs resource allocation at the investment level.

Protocol 3: Determining When and How to Change the Overall Transactional Risk Fraction

Each transaction constitutes a set of investments that, when “cashed in”, result in an increase or decrease in the investor's total wealth W. Typically, wealth increases with each transaction, but, owing to the stochastic nature of these transactions, wealth sometimes shrinks. Thus, at 96 the routine checks to determine whether the investor is ruined, i.e., whether all assets have been depleted. If so, the transactions are halted at 97. If not, the routine checks at 98 to see if total wealth has increased. If so, the routine returns to 91. If not, the routine, at 99, maintains or increases, but does not reduce, the overall transactional risk fraction and then returns to 92.

Protocol three simply dictates that the overall transactional risk fraction's upper bound Rₘₐₓ, proportionality constant α, and the overall wealth W used in protocol one equations (12) and (15) must not be decreased if the last transaction resulted in a loss; otherwise, these numbers may be changed to reflect the investor's increased wealth and/or changing risk tolerance.

The rationale for this restriction is rooted in the mathematics governing the growth and/or shrinkage of wealth occurring over a series of transactions. Although it is human nature to reduce transactional risk after losing assets in a previous transaction, this is the worst—that is, the least profitable, over the long-term—action the investor can take. In order to maximize long-term wealth over a series of FRANTiC transactions, the investor should either maintain or increase the overall transactional risk following a loss, assuming that the statistical nature of the FRANTiC problem is unchanged. The only time it is wise to reduce overall transactional risk is following a profitable transaction that increases wealth (see FIG. 13). It is also permissible to increase overall transactional risk following a profitable transaction, assuming the investor is willing to accept the resulting change in her/his probability of ruin.

In many practical applications there will be transactions outstanding at all times. In such cases, the value of wealth W to be used in equations (15) and (20) is, itself, a non-deterministic quantity that must be estimated by some method. The worst-case (i.e., most conservative) estimate of W is the current wealth on-hand (i.e., not presently committed to transactions), minus any and all losses resulting from the total failure of all outstanding transactions. As with the estimate of Rₘₐₓ in Appendix II, this worst-case estimate of W is included in order to satisfy the requirement that one skilled in the field be able to implement the invention.

The prior art for risk allocation is dominated by so-called log-optimal growth portfolio management strategies. These form the basis of most financial portfolio management techniques and are closely related to the Black-Scholes pricing formulas for securities options. The prior art risk allocation strategies make the following assumptions:

1. The cost of the transaction is negligible.

2. Optimal portfolio management reduces to maximizing the rate at which the investor's wealth doubles (or, equivalently, the rate at which it grows).

3. Risk should be allocated in proportion to the probability of a profitable transaction, without regard to the specific expected value of the profit.

4. It is more important to maximize the long-term growth of an investor's wealth than it is to control the short-term volatility of that wealth.

The invention described herein makes the following substantially different assumptions:

1. The cost of the transaction is significant; moreover, the cumulative cost of transactions can lead to financial ruin.

2. Optimal portfolio management reduces to maximizing an investor's profits in any given time period.

3. Risk should be allocated in inverse proportion to the expected profitability β of a transaction (see equations (12-(13) and (16)-(20)): consequently, all transactions made with the same risk fraction R should yield the same expected profit, thus ensuring stable growth in wealth.

4. It is more important to realize stable profits (by maximizing short-term profits), maintain stable wealth, and minimize the probability of ruin than it is to maximize long-term growth in wealth.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of training a neural network model to classify input patterns or assess the value of decisions associated with input patterns, wherein the model is characterized by interrelated, numerical parameters, which are adjustable, by numerical optimization, the method comprising:
comparing an actual classification or value assessment produced by the model in response to a predetermined input pattern with a desired classification or value assessment for the predetermined input pattern, the comparison being effected on the basis of an objective function which includes one or more terms,
each of the terms being a synthetic term function with a variable argument δ and having a transition region for values of δ near zero, the term function being symmetric about the value δ=0 within the transition region; and
using the result of the comparison to govern the numerical optimization by which parameters of the model are adjusted.

2. The method of claim 1, wherein each term function is a piece-wise amalgamation of differentiable functions.

3. The method of claim 1, wherein each term function has the attribute that the first derivative of the term function for positive values of δ outside the transition region is not greater than the first derivative of the term function for negative values of δ having the same absolute values as the positive values.

4. The method of claim 1, wherein each term function is piecewise differentiable for all values of its argument δ.

5. The method of claim 1, wherein each term function is monotonically non-decreasing so that it does not decrease in value for increasing values of its real-valued argument δ.

6. The method of claim 1, wherein each term function is a function of a confidence parameter ψ and has a maximal slope at δ=0, the slope being inversely proportional to ψ.

7. The method of claim 1, wherein each term function has a portion for negative values of δ outside the transition region which is a monotonically increasing polynomial function of δ having a minimal slope which is linearly proportional to a confidence parameter.

8. The method of claim 1, wherein each term function has a shape that is smoothly adjustable by a single real-valued confidence parameter ψ, which varies between zero and one, such that the term function approaches a Heaviside, step function of its argument δ when ψ approaches zero.

9. The method of claim 8, wherein the term function is an approximately linear function of its argument delta when ψ=1.

10. The method of claim 8, wherein
each term function has the attribute that the first derivative of the term function for positive values of δ outside the transition region is not greater than the first derivative of the term function for negative values of δ having the same absolute values as the positive values,
each term function is a function of a confidence parameter ψ and has a maximal slope at δ=0, the slope being inversely proportional to ψ,
each term function having a portion for negative values of δ outside the transition region which is a monotonically increasing polynomial function of δ having a minimal slope, which is linearly proportional to ψ,
each term function is piecewise differentiable for all values of its argument δ, and
each term function is monotonically non-decreasing so that it does not decrease in value for increasing values of its real-valued argument δ.

11. A method of learning to classify input patterns and/or to assess the value of decisions associated with input patterns, the method comprising:
applying a predetermined input pattern to a neural network model of concepts that need to be learned to produce an actual output classification or decisional value assessment with respect to the predetermined input pattern, wherein the model is characterized by interrelated, adjustable, numerical parameters;
defining a monotonically non-decreasing, anti-symmetric, everywhere piecewise differentiable objective function;
comparing the actual output classification or decisional value assessment with a desired output classification or assessed decisional value for the predetermined input pattern on the basis of the objective function; and
adjusting the parameters of the model by numerical optimization governed by the result of the comparison.

12. The method of claim 11, wherein the neural network model produces N output values in response to the predetermined input pattern, where N>1.

13. The method of claim 12, wherein the objective function includes N−1 terms, wherein each term is a function of a differential argument δ.

14. The method of claim 13, wherein for each term the value of δ is the difference between the value of the output representing the correct classification/value assessment and a corresponding one of the other output values.

15. The method of claim 12, wherein when the example being learned is incorrectly classified or value-assessed, the objective function includes a single term which is a function of a variable argument δ, wherein the value of δ is the difference between the value of the output representing the correct classification/value assessment and the greatest other output value.

16. The method of claim 11, wherein the neural network model produces a single output value in response to the predetermined input pattern.

17. The method of claim 16, wherein the objective function includes a function of a variable argument δ, wherein 6 is the difference between the single output value and a phantom output which is equal to the average of the maximal and minimal values that the output can assume.

18. Apparatus for training a neural network model to classify input patterns or assess the value of decisions associated with input patterns, wherein the model is characterized by interrelated, numerical parameters adjustable by numerical optimization, the apparatus comprising:
comparison means for comparing an actual classification or value assessment output produced by the model in response to a predetermined input pattern with a desired classification or value assessment output for the predetermined input pattern,
the comparison means including a component effecting the comparison on the basis of an objective function which includes one or more terms,
each of the terms being a synthetic term function with a variable argument δ and having a transition region for values of δ near zero, the term function being symmetric about the value δ=O within the transition region; and
adjustment means coupled to the comparison means and to the associated neural network model and responsive to a result of a comparison performed by the comparison means to govern the numerical optimization by which parameters of the model are adjusted.

19. The apparatus of claim 18, wherein each term function is a piece-wise amalgamation of differentiable functions.

20. The apparatus of claim 18, wherein each term function has the attribute that the first derivative of the term function for positive values of δ outside the transition region is not greater than the first derivative of the term function for negative values of δ having the same absolute values as the positive values.

21. The apparatus of claim 18, wherein each term function is piecewise differentiable for all values of its argument δ.

22. The apparatus of claim 18, wherein each term function is monotonically non-decreasing so that it does not decrease in value for increasing values of its real-valued argument δ.

23. The apparatus of claim 18, wherein each term function is a function of a confidence parameter ψ and has a maximal slope at δ=0, the slope being inversely proportional to ψ.

24. The apparatus of claim 18, wherein each term function has a portion for negative values of δ outside the transition region which is a monotonically increasing polynomial function of δ having a minimal slope which is linearly proportional to a confidence parameter.

25. The apparatus of claim 18, wherein each term function has a shape that is smoothly adjustable by a single real-valued confidence parameter ψ, which varies between zero and one, such that the term function approaches a Heaviside, step function of its argument δ when ψ approaches zero.

26. The apparatus of claim 25, wherein the term function is an approximately linear function of its argument δ when ψ=1.

27. The apparatus of claim 25, wherein each term function has the attribute that the first derivative of the term function for positive values of δ outside the transition region is not greater than the first derivative of the term function for negative values of δ having the same absolute values as the positive values,
each term function is a function of a confidence parameter ψ and has a maximal slope at δ=0, the slope being inversely proportional to ψ,
each term function having a portion for negative values of δ outside the transition region which is a monotonically increasing polynomial function of δ having a minimal slope, which is linearly proportional to ψ,
each term function is piecewise differentiable for all values of its argument at δ, and
each term function is monotonically non-decreasing so that it does not decrease in value for increasing values of its real-valued argument δ.

28. Apparatus for learning to classify input patterns and/or assessing the value of decisions associated with input patterns, the apparatus comprising:
a neural network model of concepts that need to be learned, the model being characterized by interrelated, adjustable, numerical parameters,
the neural network model being responsive to a predetermined input pattern to produce an actual classification or decisional value assessment output,
comparison means for comparing the actual output with a desired output for the predetermined input pattern on the basis of a monotonically non-decreasing, anti-symmetric, everywhere piecewise differentiable objective of function, and
means coupled to the comparison means and to the neural network model for adjusting parameters of the model by numerical optimization governed by a result of a comparison performed by the comparison means.

29. The apparatus of claim 28, wherein the neural network model produces N output values in response to the predetermined input pattern, where N>1.

30. The apparatus of claim 29, wherein the objective function includes N−1 terms, wherein each term is a function of a differential argument δ.

31. The apparatus of claim 30, wherein for each term the value of δ is the difference between the value of the output representing the correct classification/value assessment and a corresponding one of the other output values.

32. The apparatus of claim 29, wherein when the example being learned is incorrectly classified or value-assessed, the objective function includes a single term which is a function of a variable argument δ, wherein the value of δ is the difference between the value of the output representing the correct classification/value assessment and the greatest other output value.

33. The apparatus of claim 28, wherein the neural network model produces a single output value in response to the predetermined input pattern.

34. The apparatus of claim 33, wherein the objective function includes a function of a variable argument δ, wherein δ is the difference between the single output value and a phantom output, which is equal to the average of the maximal and minimal values that the output can assume.

35. A method of learning to classify input patterns and/or to assess the value of decisions associated with input patterns, the method comprising:
applying a predetermined input pattern to a neural network model of concepts that need to be learned to produce one or more output values and an actual output classification or decisional value assessment with respect to the predetermined input pattern, wherein the model is characterized by interrelated, adjustable, numerical parameters; and
comparing the actual output classification or decisional value assessment with a desired output classification or decisional value assessment for the predetermined input pattern on the basis of an objective function which includes one or more terms, each term being a function of the difference between a first output value and either a second output value or the midpoint of the dynamic range of the first output value, such that the method of learning can, independently of the statistical properties of data associated with the concepts to be learned and independently of the mathematical characteristics of the neural network, guarantee that (a) no other method of learning will yield greater classification or value assessment correctness for a given neural network model, and (b) no other method of learning will require a less complex neural network model to achieve a given level of classification or value assessment correctness.

36. The method of claim 35, wherein each term is a synthetic term function with a variable argument δ and having a transition region for values of δ near zero, the term function being symmetric about the value δ=0 within the transition region.

37. The method of claim 36, wherein each term function has the attribute that the first derivative of the term function for positive values of δ outside the transition region is not greater than the first derivative of the term function for negative values of δ having the same absolute values as the positive values.

38. The method of claim 36, wherein each term function is piecewise differentiable for all values of its argument δ.

39. The method of claim 36, wherein each term function is monotonically non-decreasing so that it does not decrease in value for increasing values of its real-valued argument δ.

40. The method of claim 36, wherein each term function has a shape that is smoothly adjustable by a single real-valued confidence parameter ψ, which varies between zero and one, such that the term function approaches a Heaviside, step function of its argument δ when ψ approaches zero.

41. The method of claim 40, wherein the term function is an approximately linear function of its argument δ when ψ=1.

42. The method of claim 36, wherein each term function is a piece-wise amalgamation of differentiable functions.

43. A method of allocating resources to a transaction which includes one or more investments, so as to optimize profit, the method comprising:
determining a risk fraction of total resources to be devoted to the transaction based on a predetermined risk tolerance level and in inverse proportion to expected profitability of the transaction;
identifying profitable investments of the transaction utilizing a teachable value assessment neural network model;
determining portions of the risk fraction of total resources to be allocated respectively to profitable investments of the transaction;
conducting the transaction; and
modifying the risk tolerance level and/or the risk fraction of total resources based on whether and how the transaction has affected total resources.

44. The method of claim 43, wherein the expected profitability of the transaction is determined by utilizing a teachable value assessment neural network model to assess possible transactions.

45. The method of claim 43, wherein the modifying step includes modifying the risk tolerance level to reflect an increase in total resources.

46. The method of claim 45, wherein the modifying step includes modifying the risk fraction of total resources to reflect a change in the risk tolerance level.

47. The method of claim 43, wherein in the event that the transaction has not increased total resources, the modifying step includes only maintaining or increasing, but not reducing, the risk fraction of total resources.

48. The method of claim 43, and further comprising determining whether or not resources have been exhausted immediately after conducting the transaction.

49. The method of claim 48, wherein the modifying step is effected only in the event that the transaction has not exhausted the available resources.

50. The method of claim 43, wherein the determination of the risk fraction of total resources includes first determining the largest acceptable fraction of total resources that may be allocated to the transaction, and determining the risk fraction of total resources so that it does not exceed the largest acceptable fraction.
